(19) United States
(12) Patent Application Publication
(10) Pub. No.: US 2014/0356743 A1
(43) Pub. Date: Dec. 4, 2014

(54) Method of separating and recombining the water molecule

(71) Applicant: Peter Vanderpan, Brookings, SD (US)

(72) Inventor: Peter Vanderpan, Brookings, SD (US)

(21) Appl. No.: 13/986,760

(22) Filed: Jun. 3, 2013

(51) Int. Cl. H01M 8/06; H01M 8/04

(52) U.S. Cl. CPC H01M 8/0656; H01M 8/04097; H01M 2250/20
USPC 429/418; 429/422; 60/698

(57) ABSTRACT

An energy generating apparatus including water molecule separating device, water molecule recombining device, and water molecule recycling device, which generates various energy outputs by various means. The water separating device can be a type of machine of several designs which operates chemically and produces H2 and O2 from the water molecule. It is attached to a water recombining device of several designs which operates chemically and produces several forms of energy when recombining H2 and O2 into the water molecule. There is also a recycling device which is used to return the water molecule and its atoms to the beginning of the cycle which may or may not be used depending upon application.

### CROSS REFERENCE TO RELATED APPLICATIONS

DISCLOSURE DOCUMENT U.S. Pat. Nos. 570,870, 574,639, 596,335, 596,971

### FEDERALLY SPONSORED RESEARCH

N/A

### SEQUENCE LISTING OR PROGRAM

N/A

### BACKGROUND-PRIOR ART

Fossil fuel has long been accused as being the arch-nemesis of a healthy environment. It pollutes and its byproducts are harmful to humans and animals. Now the prices have risen in some parts of the country to more than four dollars per gallon. The industry is now Frasching (fracking) the rock strata, which may not be good for the bedrock. It may not be the greatest catastrophe should an oil pipeline burst. The infrastructure is getting old. It has assisted the building of the free world and may now succumb to the future. It may be relegated to the major industrial categories of lubricants and asphalt. The worthy problem solving genius associated with wind, solar and bio-energy has not solved the problems associated with growing our food, making our clothes and homes or keeping us warm in this the spring of our discontent.

The pathway into the future which regards energy consumption may very well require a simple course correction. That course correction may very well be focused upon the transfer from fossil fuel to a concept which is capable of recycling the water molecule.

### SUMMARY

My work on this subject and method began late in 1998 when I began to search for a way to solve America's dependency upon foreign oil. The price for gasoline had risen to an astounding one dollar a gallon with no relief insight. I purchased several text books concerning chemistry, physics, natural science and combustion engines, hoping to find something not yet assembled from which I could gain solution. I gained these insights from these text books.

a) The chemistry textbook told me of the ionization of water, different solutions, and that which liberated, plated or what was left in solution.
b) The physical science book spoke of Faraday and coulombs.
c) The electronics manual taught me Ohm's law.
d) The physics book related how electrolytic cells and fuel cells worked.
e) The combustion engine book was concerned with horsepower, BTU's heat values and efficiencies to name a few.

I realized that these scientific principles could be connected together if the Law of Conservation of Matter and Energy was observed. Individually, the endothermic reaction is a complete element of the law, as is the exothermic reaction as is condensation. The endothermic reaction uses 96′500 coulombs to separate the water molecule; while the exothermic reaction generally releases 102′725 BTU's which can be translated into different energy types. Condensation can be used as a third energy transfer as the water molecule is returned to the endothermic reaction of my device. What remained was a properly designed and interrelated machine that functionally incorporated these scientific principles.

This utilitarian concept is useful for all forms of energy generation as they relate to the separation and recombination of the water molecule. Those machines assembled in such a manner as to make a new use machine which produce electrical, mechanical and gasses are among other forms. A member of this device uses an electrolytic cell or similar machine for use in separating the water molecule (H2O) by use of endothermic reaction initiated by an electric current passed through a chemical solution such as lends itself to the process. A further member of this device collects the gasses of H2 and O2 in an old use machine, such as a fuel cell, combustion engine or others which generate various forms of energy. With the above or other members, the water output of the exothermic reaction is condensed, collected, transported and stored by an old use machine and sent to the electrolytic cell, where it is ready to be separated and the process began again.

### Advantages

Accordingly, the process' first advantage is that endothermic reactions, exothermic reactions and condensation are scientific principles with known values able to produce a calculable supply of manufactured energy, when properly coupled. Another advantage is that the water vapor is non-polluting Another advantage is that the needed machines already exist, and there is not a requirement to design and fabricate any new machines but rather modify existing old use machines. Another advantage is the water is readily available. Another advantage is that any prime mover that is energized by fossil fuel can be energized by H2 and O2 as well as those run by mechanical energy and all forms of electricity. Another advantage is that H2 and 02 are combustible gasses which combine to form water which is a central need for the existence of life as we know it. Another advantage is that the recombination of these gasses is also capable of causing an energy output. Other advantages will become apparent from the consideration of the drawings and ensuing descriptions.

### DRAWINGS

### Figures

In the drawings, a member of the device will have a Roman numeral and a location upon the device will have an alphabetic designation.

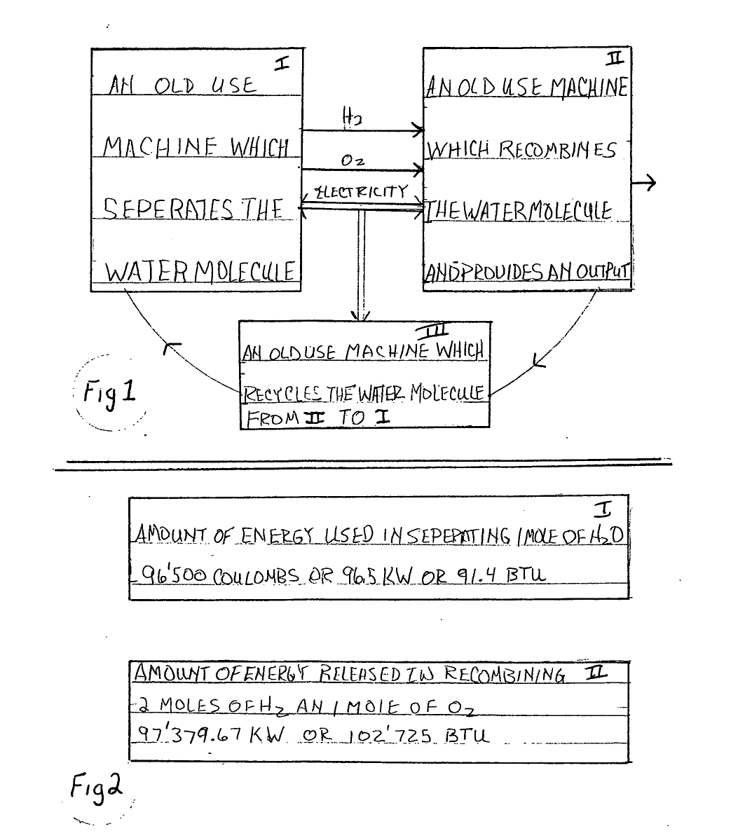

FIG. 1 is a flow chart showing the gas and electricity flow outside the device members I, II, III as well as the return flow from II to I through device member III. As will be seen, the return flow is not necessary on some embodiments.

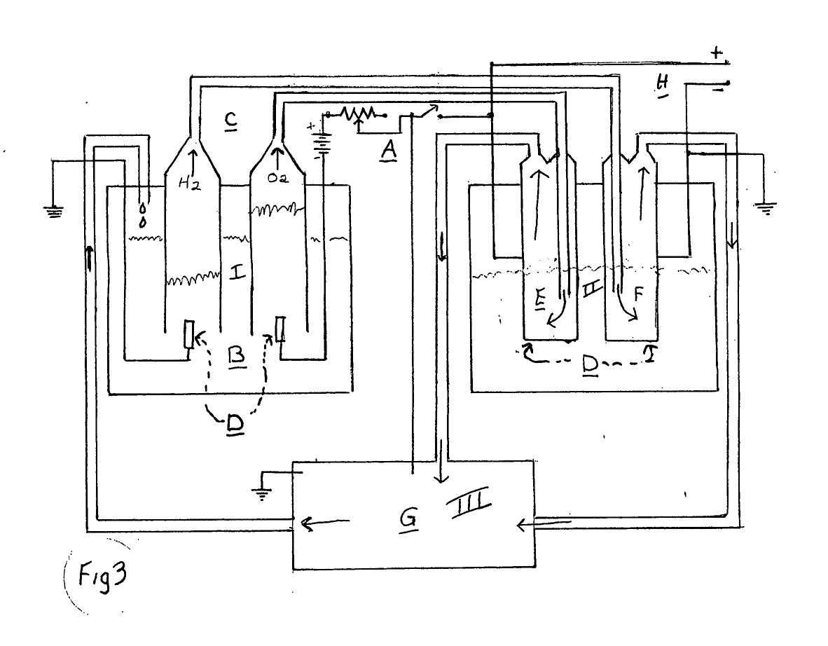

FIG. 2 shows two charts concerning the energy requirement of device member I, expresses in coulombs per mole as well as the energy requirements of device member II, a combustion engine, fuel cell, or such, expressed in Kilowatts and BTUs per mole.

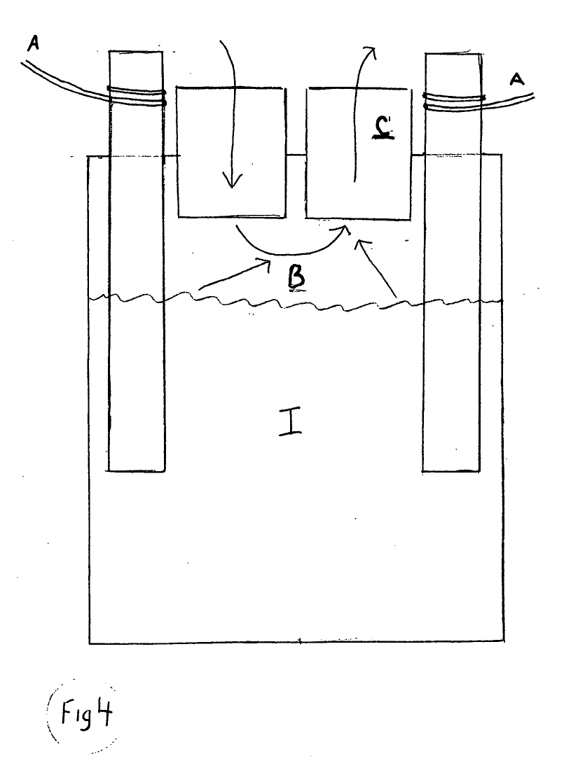

FIG. 3 is a mechanical drawing of an embodiment of the machine shown in FIG. 1 flowchart; an electrolytic cell (I), a fuel cell (II) and a return (III). The machine may be a radiator and accessories.

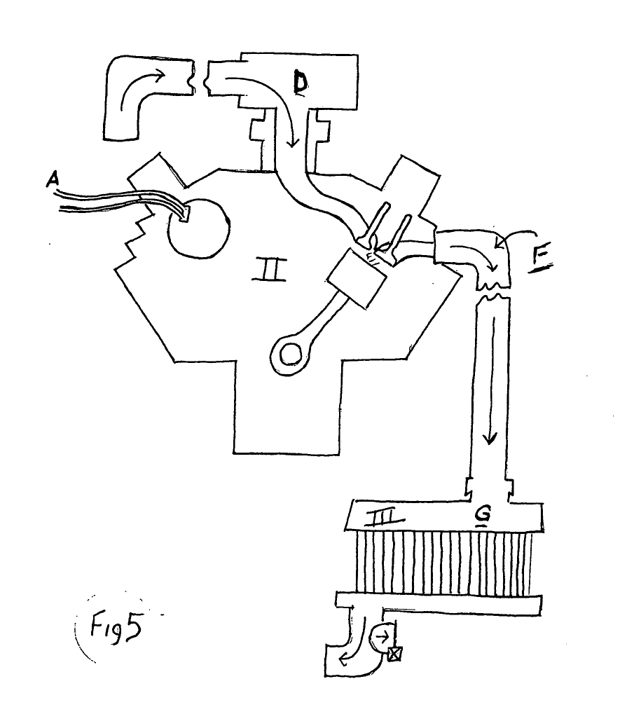

FIGS. 4 & 5 are mechanical drawings of an automotive style machine with optional return. Given the availability of water and the environmental competency of the exhaust, the return may be omitted on this machine. This machine provides a mechanical as well as an electrical output.

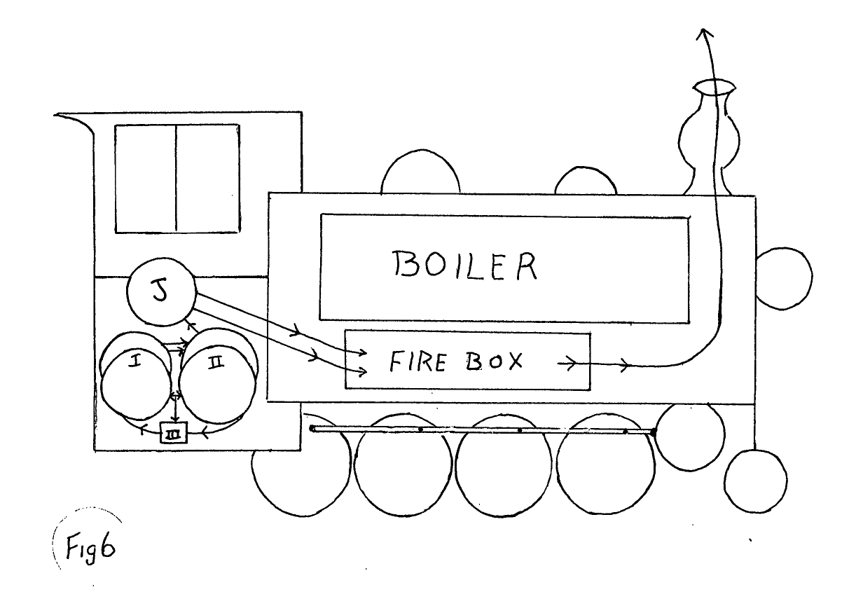

FIG. 6 is a drawing of a steam locomotive showing the machine as an electrolytic cell and fuel cell with return. An additional electrolytic cell, not part of the machine and designated as (J) is added to provide H2 and 02 to burners in the firebox. They will energize the steam locomotive, and be exhausted.

### DRAWINGS

### Reference Symbols

Electrolytic Cell, Separator I
Engine, Fuel Cell, Recombiner II
Radiator, Return III
Switch and Power Supply A
Electrolytic cell B
Gas Collectors C
Electrodes D
Solution E & F
Return G
Output H
Secondary Stage J

### Description and Operation of FIG. 3-Specification

The basic process is illustrated in FIG. 3. All embodiments, regardless of size, output or individual machine or manufacture will use endothermic and exothermic reactions and will function with scientific precision with or without regard to the presence or absence of a return.

The machine is energized (A) when the switch is placed in the closed position and current from the battery energizes the complete system beginning the electrolysis of the water molecule (H2O) in the electrolytic cell (B). H2 and O2 are then electrolyzed from the solution and sent from (C) the collectors in the electrolytic cell to the (D) electrodes of the fuel cell. The H2 and O2 are then recombined in the solution E & F and the excess H2 and O2 and H2O are sent to the return where they are stored and sent to (B) where the process begins again. The electrical output is taken at (H). There is however a variation. The return is omitted and the water is vented and later manually added to the system.

### Embodiment

### FIGS. 4&5

There are many embodiments. As many as there are types and sizes of combustion engines, electrolytic cells and all other separating and recombining machines. The simplest embodiment to build which proves the scientific principles will be the machine located on FIGS. 4&5.

The skills required include drilling, cutting, gluing, measuring, and running wires and the use of a pliers, wrench and screwdriver. The first thing necessary is to have an operable vehicle in which to install the parts. The vehicle represents the recombining exothermic reaction machine in the form of a combustion engine and power supply. What remains is to build and install the separating endothermic reaction machine in the form of an electrolytic cell.

A jar composed of glass or plastic can be used as the tank to hold the solution used to electrolyze, the water molecule. It should be about the size of a gallon with sufficient opening to house the air inlet and outlet as well as the electrical posts, the anode and cathode, also known as electrodes. They will supply the battery voltage to the solution. The solution in this embodiment is basic battery acid, sulfuric acid, and can be found at your local automotive parts store.

The posts can be made of threaded aluminum stock or wrapped aluminum foil or similar material which can be used as anodes and cathodes. They should be fastened with nuts and washers or glue or hose clamps or similar adaptive fasteners. The inlet and outlet made of PVC pipe and various fittings, found at your favorite hardware store should be sealed with pipe dope. The outlet PVC pipe, transporting the H2 and O2 should be of sufficient length to connect the electrolytic cell to the combustion engine intake. The intake should be properly vented to insure proper air flow. The electrolytic cell should be fitted in a frame and in a safe place to protect it from jolts and collisions, and you from noxious fumes. When you run the pipe, make sure you have sufficient air flow.

Run a double wire of sufficient gauge for the positive and negative posts of the electrolytic cell from a switched circuit. Control can be accomplished with an on-off switch, a variable position blower switch connected in series between the circuit and the electric cell and located in the driver's compartment. Another input power design can be a voltage inverter to a transformer power supply of adequate wattage to generate a well regulated system input.

The drilling of any necessary holes can be accomplished by the use of a hole saw or drill bit and power drill. When completely assembled, fill the jar one-half full with water and then one-third full with sulfuric acid. Always add the water first and then the sulfuric acid and not in reverse, given the volatile nature of sulfur. When properly connected, energizing the switch or the circuit will cause the electrolytic cell to bubble and begin to breakdown the water molecule. When operating the vehicle, start the combustion engine first and then the machine embodiment.

When accelerating the vehicle, the engine will naturally aspirate the H2 and O2 from the cell and the alternator will increase the current when it is designed to do so. RPM is controlled by the accelerator and air flow. You can also block the outside air intake and cause all the air to flow solely through the electrolytic cell.

### Embodiment Variation

Another variation is to add several electrolytic cells in series carefully calculating the proper output in a manner similar to a voltage divider. Some engines among this group of machines which produce rotary motion are designed to run exclusively on hydrogen and some are H2 and O2 assisted gasoline or diesel engines. Others however are electric and require other inputs and modifications to the machine embodiments.

### Advantages

This embodiment and variations can be built with parts readily accessible to the individual. All parts are available from local stores. Basic skills and scientific knowledge are required.

### RAMIFICATIONS, AND SCOPE

This method is a process, a manufacture, a new use, a machine, and a composition of matter specifically for the separation and recombination of the water molecule. Water is an abundant resource and an extremely capable energy source.

The economy will benefit from the manufacture and sale of the product. The freeing up of the monies being spent purchasing fuel for electricity, transportation, and heating will benefit other areas of the general American economy well as other national economies and the world. More over, it will free America from its dependency upon foreign oil and nuclear energy.

### CONCLUSION

While the above description contains many variations, these should not be construed as limitations on the scope of embodiment. These are examples of various embodiments thereof. Many other ramifications and variations are possible within the teachings of the various embodiments. For example, interstellar flight, power supply for ion engines, power for life support for polar exploration.

Thus the scope should be determined by the appended claims and their legal equivalents and not by the examples given.

A. Method for separating and recombining the water molecule, comprising,
a. providing the said separating is initiated by an energy source and is accomplished in a means using endothermic reaction
separating the water molecule into H2 and O2 and providing an output for the gasses and transferring the said gassed to a recombining device, where,
b. said recombining is accomplished in a means which uses exothermic reaction thereby recombining the atoms of H2 and O2 into the water molecule, generating a form of energy depending upon the type of recombining device, and transferring the gasses to a return device, and,
c. providing a return means that cools,
stores and transfers the water molecule to the separating means to begin the process again, and,
d. providing a variation of the method where the return is omitted, and,
e. whereby, the water molecule is separated and recombined causing an energy output.

A. A water molecule separating and recombining machine, comprising,
a. a separating device, in part, power source selected from a group of machines which generate energy and include, wind generators, solar cells, batteries, fossil fuel generators, and such which provide energy for the separating device which separated the water molecule into H2 and O2, from a group of devices such as electrolytic cells, laboratory devices and other machines, and transferring the said H2 and O2 by means from a group of tubes or pumps and hoses and coupled to
b. the recombining device, selected from a group of combustion engines, fuel cells, turbines, or such engines which recombine the said H2 and O2 into the water molecule and produce energy outputs such as rotational energy or electrical energy or such energy outputs that the machines generate, and is connected to,
c. a return device, from a group of radiators, pumps, tanks, hoses and such which condense, store, and transfer the water molecule to the said separating device to begin the process again, and,
d. a machine variation where the return is omitted,
e. whereby, a machine which separates and recombines the water molecule and generates an electric current.
An energy output generated as a result of the recombination of H2 and O2, which was the product of the separation of the water molecule, which was initiated by an energy source, and a recycling link which transports the molecules and/or atoms from the recombination to the separation, if desired, whereby the composition makes a calculable and consistent energy source.

A. A Separating and Recombining Machine of the Water Molecule, comprising,
a. a separating machine-element that will electrolyze the said water molecule into the atoms of H2 and O2 when energized with an energy source and cause an output of gasses, and,
b. a recombining machine-element that will recombine the said gasses into the water molecule and generate an energy output according to the specific said recombining machine-element's design, and
c. a return machine-element capable of receiving the water molecule in any state and transfer to the separating machine-element and repeat the process, and,
d. a manufacture which omits the return machine-element, but provides manual means to exhaust and replenish the water molecule,
e. whereby, the said machine-elements will separate and recombine the water molecule causing an energy output.
A method for separating, recombining and returning the water molecule in a process by using old use machines as new use machines and providing an energy input to cause the process to function as well as initiating an energy output for other processes, machines and manufactures, and a variation where the old use machine providing the return is omitted.
